(19) United States
(12) Patent Application Publication
(10) Pub. No.: US 2020/0234594 A1
(43) Pub. Date: Jul. 23, 2020

(54) INFORMATION PROCESSOR, VEHICLE MANAGEMENT SYSTEM, AND INFORMATION PROCESSING METHOD

(71) Applicant: TOYOTA JIDOSHA KABUSHIKI KAISHA, Toyota-shi (JP)

(72) Inventors: Hiromichi DOGISHI, Nagoya-shi (JP); Masaki SHITARA, Nagakute-shi (JP); Keiji YAMASHITA, Nisshin-shi (JP); Nozomi KANEKO, Nagoya-shi (JP); Naoki YAMAMURO, Nagoya-shi (JP); Shunsuke TANIMORI, Susono-shi (JP); Ryoichi SHIRAISHI, Anjo-shi (JP)

(73) Assignee: TOYOTA JIDOSHA KABUSHIKI KAISHA, Toyota-shi (JP)

(21) Appl. No.: 16/701,247

(22) Filed: Dec. 3, 2019

(30) Foreign Application Priority Data
Jan. 23, 2019 (JP) 2019-009659

(51) Int. Cl. G08G 1/00; G05D 1/02; G05D 1/00; G06Q 10/04

(52) U.S. Cl. CPC G08G 1/202; G06Q 10/04; G05D 1/0088; G05D 1/0287

(57) ABSTRACT

Under a situation where plural vehicles are dispatched to different areas, an information processor acquires sales information that includes information on a sales quantity of a specified product or a specified service by each of the vehicles. Then, on the basis of the acquired sales information, the information processor forecasts a demand for the specified product or the specified service in each of the areas where the vehicles are dispatched. Furthermore, on the basis of the forecasted demand, the information processor determines a redispatch area that is an area where each of the plural vehicles is redispatched, and sends a move command for moving each of the plural vehicles to the respective redispatch area to each of the plural vehicles.

### INCORPORATION BY REFERENCE

The disclosure of Japanese Patent Application No. 2019-009659 filed on Jan. 23, 2019 including the specification, drawings and abstract is incorporated herein by reference in its entirety.

### BACKGROUND

### 1. Technical Field

The disclosure relates to an information processor, a vehicle management system, and an information processing method.

### 2. Description of Related Art

Recently, development of vehicles capable of autonomous travel has been progressed. In conjunction therewith, development of a technique related to various systems that provide users with products and services by using the vehicles capable of the autonomous travel has also been progressed. For example, in Japanese Patent Application Publication No. 2018-124676 (JP 2018-124676 A), a technique related to an online delivery system that accepts designation of a package delivery method using an autonomous driving vehicle is disclosed.

### SUMMARY

The disclosure has a purpose of providing a technique capable of promoting a sale of a product or a service at the time when the product or the service is sold to a user by a store vehicle.

An information processor according to a first aspect of the disclosure is an information processor that manages travel of plural vehicles capable of autonomous travel. Each of the plural vehicles is a store vehicle that sells the same specified product or the same specified service to a user. The information processor includes a control section that: acquires sales information that includes information on a sales quantity of the specified product or the specified service by each of the vehicles under a situation where the plural vehicles are dispatched to different areas; forecasts a demand for the specified product or the specified service in each of the areas where the vehicles are dispatched on the basis of the sales information acquired from each of the plural vehicles; determines a redispatch area that is an area where each of the plural vehicles is redispatched on the basis of the forecasted demand for the specified product or the specified service in each of the areas; and sends a move command for moving each of the plural vehicles to the respective determined redispatch area to each of the plural vehicles.

A vehicle management system according to a second aspect of the disclosure is a vehicle management system that has: plural vehicles capable of autonomous travel; and an information processor that manages travel of the plural vehicles. Each of the plural vehicles is a store vehicle that sells the same specified product or the same specified service to a user. The information processor includes: a first control section that acquires sales information that includes information on a sales quantity of the specified product or the specified service by each of the vehicles under a situation where the plural vehicles are dispatched to different areas, forecasts a demand for the specified product or the specified service in each of the plural areas where the vehicles are dispatched on the basis of the sales information acquired from each of the plural vehicles, determines an area where each of the plural vehicles is redispatched on the basis of the forecasted demand for the specified product or the specified service in each of the plural areas, and sends a move command for moving each of the plural vehicles to the respective determined redispatch area to each of the plural vehicles; and a second control section that makes each of the plural vehicles send the sales information to the information processor, receives the move command to the redispatch area that is sent from the information processor, and moves a host vehicle to the redispatch area on the basis of the received move command.

An information processing method according to a third aspect of the disclosure is an information processing method for managing travel of plural vehicles capable of autonomous travel by a computer. Each of the plural vehicles is a store vehicle that sells the same specified product or the same specified service to a user. The information processing method includes: acquiring sales information that includes information on a sales quantity of the specified product or the specified service by each of the vehicles under a situation where the plural vehicles are dispatched to different areas; forecasting a demand for the specified product or the specified service in each of the plural areas where the vehicles are dispatched on the basis of the sales information acquired from each of the plural vehicles; determining an area where each of the plural vehicles is redispatched on the basis of the forecasted demand for the specified product or the specified service in each of the plural areas; and sending a move command for moving each of the plural vehicles to the respective determined redispatch area to each of the plural vehicles.

A program according to a fourth aspect of the disclosure is a program that makes a computer manage travel of plural vehicles capable of autonomous travel. Each of the plural vehicles is a store vehicle that sells the same specified product or the same specified service to a user. The program makes the computer: acquire sales information that includes information on a sales quantity of the specified product or the specified service by each of the vehicles under a situation where the plural vehicles are dispatched to different areas; forecast a demand for the specified product or the specified service in each of the plural areas where the vehicles are dispatched on the basis of the sales information acquired from each of the plural vehicles; determine an area where each of the plural vehicles is redispatched on the basis of the forecasted demand for the specified product or the specified service in each of the plural areas; and send a move command for moving each of the plural vehicles to the respective determined redispatch area to each of the plural vehicles.

According to the disclosure, it is possible to further promote the sales of the product or the service when the store vehicles sell the product or the service to the users.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a view of a schematic configuration of a vehicle management system according to an embodiment;

FIG. 2 is a block diagram schematically illustrating an example of a functional configuration of each of a vehicle and a management server constituting the vehicle management system according to the embodiment;

FIG. 3 is a table illustrating an example of a table configuration of sales information that is stored in a sales information database;

FIG. 4 is a flowchart of a procedure of dispatch determination processing; and

FIG. 5 is a sequence chart illustrating flows of the information and the processing in the vehicle management system.

### DETAILED DESCRIPTION OF EMBODIMENTS

An information processor according to a first embodiment is a device that manages travel of plural vehicles capable of autonomous travel. Here, the plural vehicles capable of the autonomous travel are store vehicles that sell the same specified product or the same specified service to users. That is, the vehicles that are management targets by the information processor are moving stalls, each of which sells the specified product or the specified service.

The plural vehicles capable of the autonomous travel can be dispatched to different areas by means of the autonomous travel. Then, since the plural vehicles are dispatched to the different areas, the specified product or the specified service can be sold to the users in the plural areas. At this time, under a situation where the plural vehicles are dispatched to the different areas, a control section of the information processor acquires sales information from each of the vehicles. This sales information includes information on a sales quantity of the specified product or the specified service by each of the vehicles.

Then, on the basis of the sales information acquired from each of the plural vehicles, the control section forecasts a demand for the specified product or the specified service in each of the areas where the vehicles are dispatched. That is, the control section forecasts a size of the potential sales of the specified product or the specified service in each of the areas where the vehicles are dispatched.

Furthermore, on the basis of the forecasted demand for the specified product or the specified service in each of the areas, the control section determines redispatch areas, to each of which the vehicle is redispatched. That is, the control section determines the redispatch area of each of the vehicles so as to move each of the vehicles, which sells the specified product or the specified service, between the areas. Then, the control section sends a move command for moving each of the vehicles to the determined redispatch area to each of the vehicles. As a result, the vehicle that receives the move command is moved from the area where the vehicle is currently dispatched to the redispatch area.

According to the above information processor, it is possible to move each of the vehicles, which sells the specified product or the specified service, to the area where the demand for the specified product or the specified service is especially high. As a result, in the area where the demand for the specified product or the specified service is especially high, it is possible to further expand a sales scale of the specified product or the specified service. Therefore, it is possible to further promote the sales of the specified product or the specified service.

A description will hereinafter be made on a specific embodiment with reference to the drawings. Dimensions, materials, shapes, relative arrangement, and the like of components described in this embodiment are not intended to limit the technical scope thereto unless otherwise noted.

### Embodiment

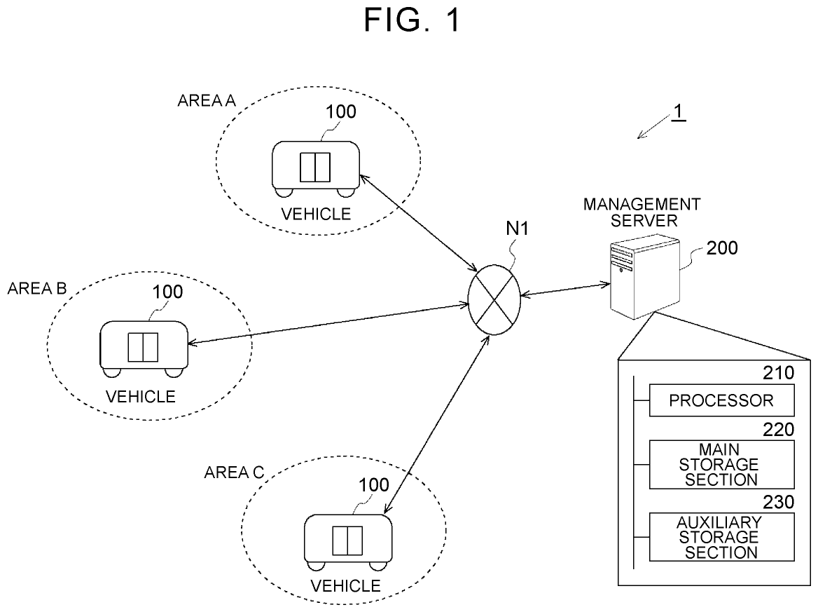

(System Overview) FIG. 1 is a view of a schematic configuration of a vehicle management system according to this embodiment. A vehicle management system 1 is configured to include plural vehicles 100 capable of autonomous travel and a management server 200. In the vehicle management system 1, each of the vehicles 100 and the management server 200 are mutually connected via a network N1. For the network N1, for example, a wide area network (WAN) that is a worldwide public telecommunication network such as the Internet or a telephone communication network for mobile phones or the like may be adopted.

Each of the vehicles 100 receives a command sent from the management server 200 via the network N1, and performs the autonomous travel on the basis of the command. The vehicles 100 are store vehicles. The plural vehicles 100 sell the same specified product to users. In the vehicle management system 1, each of the vehicles 100 is moved to a respective destination on the basis of the command sent from the management server 200. That is, each of the vehicles 100 is dispatched to an area (the destination) that is determined by the management server 200. Then, in the respective dispatched area, each of the vehicles 100 sells the specified product to the users. Note that what is sold by the vehicles 100 is not limited to the product. That is, the vehicles 100 may be store vehicles, each of which sells a specified service to the users. Also, in this case, the plural vehicles 100 sell the same specified service to the users.

The management server 200 is configured to include a general computer. The computer, which constitutes the management server 200, includes: a processor 210 such as a CPU or a DSP; a main storage section 220 such as read only memory (ROM) or random access memory (RAM); and an auxiliary storage section 230 such as an EPROM, a hard disk drive (HDD), or a removable medium. Here, the removable medium is, for example, flash memory such as USB memory or an SD card, or a disc recording medium such as a CD-ROM, a DVD, or a Blu-ray disc.

In the management server 200, an operating system (OS), various programs, various information tables, and the like are stored in the auxiliary storage section 230. In the management server 200, when the processor 210 loads the program, which is stored in the auxiliary storage section 230, to the main storage section 220 for execution, various functions, which will be described, can be realized. Some or all of the functions of the management server 200 may be realized by a hardware circuit such as an ASIC or an FPGA. Note that the management server 200 does not always have to be realized by a single physical configuration but may be realized by plural computers that cooperate with each other.

The management server 200 acquires and manages sales information on the specified product from each of the vehicles 100. The sales information includes information on a sales quantity of the specified product by each of the vehicles 100. In addition, the management server 200 determines the area where each of the vehicles 100 is dispatched. More specifically, the management server 200 first dispatches the plural vehicles 100 to the different areas (areas A, B, C . . . ). At this time, the plural areas where the vehicles 100 are dispatched may be areas that are selected by an administrator of the vehicle management system 1 according to the specified product.

Under the situation where the plural vehicles 100 are dispatched to the different areas, the management server 200 acquires the sales information from each of the vehicles 100. At this time, the sales information acquired by the management server 200 includes the information on the sales quantity of the specified product in each of the areas where the vehicles 100 are dispatched. Thus, on the basis of the sales information acquired from each of the vehicles 100, the management server 200 forecasts a demand for the specified product in each of the areas where the vehicles 100 are dispatched. Then, on the basis of the forecasted demand for the specified product in each of the areas, the management server 200 determines redispatch areas, to each of which the vehicle 100 is redispatched. Furthermore, the management server 200 sends a move command for moving each of the vehicles 100 to the respective determined redispatch area to each of the vehicles 100.

The vehicle 100, which receives the move command from the management server 200, is moved from the area where the vehicle 100 is currently dispatched to the redispatch area by the autonomous travel. As a result, in at least one of the areas, in addition to the vehicle 100 that is originally dispatched to the area, the newly-moved vehicle 100 is also dispatched. Accordingly, in at least one of the areas, the number of the vehicles 100 that sell the specified product is increased. That is, in at least one of the areas, a sales scale of the specified product is expanded.

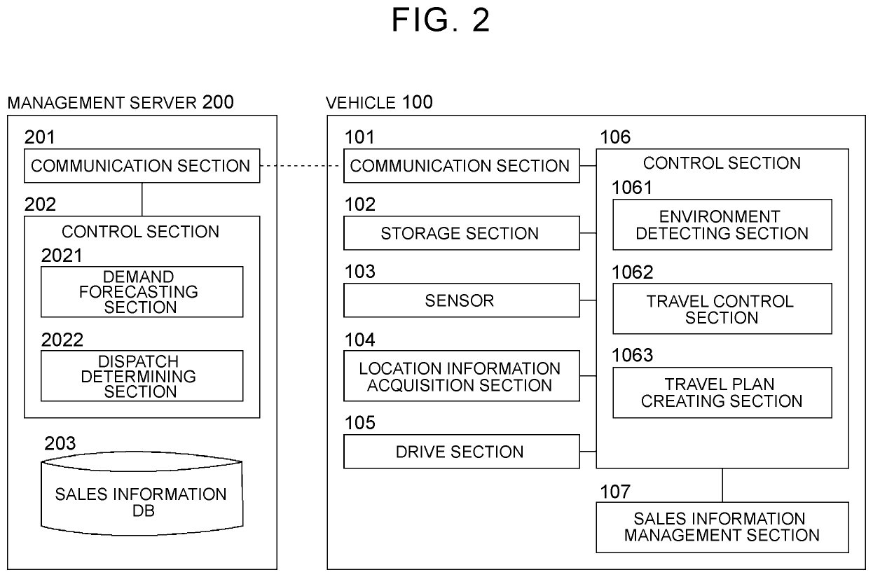

(System Configuration) Next, a description will be made on a functional configuration of each of the vehicle 100 and the management server 200 constituting the vehicle management system 1 according to this embodiment with reference to FIG. 2. FIG. 2 is a block diagram schematically illustrating an example of the functional configuration of each of the vehicle 100 and the management server 200 constituting the vehicle management system 1 according to this embodiment.

(Vehicle) As described above, the vehicle 100 is an autonomous travel vehicle that performs the autonomous travel on the basis of the command sent from the management server 200. The vehicle 100 is configured to include a communication section 101, a storage section 102, a sensor 103, a location information acquisition section 104, a drive section 105, a control section 106, and a sales information management section 107. Note that the vehicle 100 is an electric vehicle that has a motor as a prime mover. However, the prime mover of the vehicle 100 is not limited to the electric motor but may be an internal combustion engine. Alternatively, the vehicle 100 may be a hybrid vehicle that has both of the motor and the internal combustion engine as the prime movers.

The communication section 101 is a communication device that connects the vehicle 100 to the network N1. The communication section 101 can communicate with other devices including the management server 200 through the network N1 by using a mobile telecommunication service such as third generation (3G) or Long-Term Evolution (LTE). The control section 106 executes processing to send the sales information, which is managed by the sales information management section 107 described later, to the management server 200 via the communication section 101. The control section 106 also executes processing to receive the command, which is sent to the vehicle 100 from the management server 200, via the communication section 101. Note that the communication section 101 may further include a communication device that performs inter-vehicle communication with other vehicles.

The storage section 102 is a device that stores the information, and is constructed of a storage medium such as a magnetic disk or flash memory. For example, the storage section 102 stores map information. The storage section 102 also stores a travel plan of the vehicle 100 that is created by a travel plan creating section 1063 described later.

The sensor 103 is a device that senses a peripheral situation of the vehicle 100. More specifically, the sensor 103 is configured to include a stereo camera, a laser scanner, LIDAR, a radar, and the like. Information on the peripheral situation of the vehicle 100 acquired by the sensor 103 is sent to the control section 106. The location information acquisition section 104 is a device that acquires a current location of the vehicle 100, and is specifically configured to include a GPS receiver and the like. Information on the current location of the vehicle 100 acquired by the location information acquisition section 104 is sent to the control section 106.

The control section 106 has a function of executing calculation processing to control the vehicle 100. For example, the control section 106 is constructed of a microcomputer. The control section 106 has, as functional modules, an environment detecting section 1061, a travel control section 1062, and the travel plan creating section 1063. Each of the functional modules may be realized by executing a program, which is stored in a storage section such as ROM of the control section 106, by a processor such as a CPU. Some or all of the functions may be realized by a hardware circuit such as the ASIC or the FPGA.

The environment detecting section 1061 detects peripheral environment of the vehicle 100 on the basis of the information acquired by the sensor 103. For example, the environment detecting section 1061 detects objects (including a person and an animal) such as another vehicle that exists around the host vehicle. The environment detecting section 1061 also detects various targets, detection of which is required for the autonomous travel of the vehicle 100, and examples of the various targets are the number and location of a lane on a road, a road structure, and a road sign. In addition, the environment detecting section 1061 may track the detected object. In this case, for example, the environment detecting section 1061 may calculate a relative speed of the object from a difference between coordinates of the object detected in the last step and current coordinates of the object.

The travel control section 1062 controls the travel of the vehicle 100 on the basis of the travel plan stored in the storage section 102, the location information of the vehicle 100 acquired by the location information acquisition section 104, and data on the peripheral environment detected by the environment detecting section 1061. For example, the travel control section 1062 makes the vehicle 100 travel on a travel route included in the travel plan according to a travel schedule included in the travel plan. In the case where the environment detecting section 1061 detects the object that possibly collides with the vehicle 100, the travel control section 1062 executes collision avoidance control that makes the vehicle 100 travel in a manner to avoid the collision with the object. Note that a known method can be adopted as a method for causing the autonomous travel of the vehicle 100 as described above.

The travel plan creating section 1063 creates the travel plan of the host vehicle on the basis of the command received from the management server 200. For example, when receiving the move command to the redispatch area from the management server 200, the travel plan creating section 1063 creates the travel plan of the vehicle 100 that includes the travel route to the redispatch area as a destination on the basis of the map information and the like that are stored in the storage section 102.

The drive section 105 is configured to include the motor as the prime mover and mechanisms (for example, an inverter, a brake, and a steering mechanism) for the travel of the vehicle 100. The drive section 105 makes the vehicle 100 travel on the basis of a command that is generated by the travel control section 1062 to control the travel of the vehicle 100. In this way, the autonomous travel of the vehicle 100 is realized.

The sales information management section 107 is a device that manages the sales information including the sales quantity of the specified product by the vehicle 100. This sales information management section 107 is an integrated computer with the control section 106 or a separate computer from the control section 106. For example, a radio frequency identifier (RFID) tag is affixed to each of the specified products sold in the vehicle 100, and an RFID reader terminal that reads information from the RFID tag is installed in the vehicle 100. In this way, the sales information management section 107 can manage the quantity of the specified product sold to the users, and the like.

Note that the vehicle 100 does not always have to be an unattended travel vehicle. For example, a person who serves as an attendant for introducing the specified product to the user or a security personnel for security of the vehicle 100 may get on the vehicle 100. In addition, the vehicle 100 does not have to be a vehicle that always performs the autonomous travel. For example, the vehicle 100 may be a vehicle that can switch between an automated driving mode and a manual driving mode.

(Management server) The management server 200 is configured to include a communication section 201, a control section 202, and a sales information database (sales information DB) 203. The communication section 201 is a communication device that connects the management server 200 to the network N1. The communication section 201 is configured to include a local area network (LAN) interface board and a wireless communication circuit for wireless communication, for example. The control section 202 executes processing to send the move command to each of the vehicles 100 via the communication section 201. In addition, the control section 202 executes processing to receive the sales information sent from each of the vehicles 100 via the communication section 201 and to store the received sales information in the sales information DB 203. The sales information DB 203 is created in the auxiliary storage section 230 of the management server 200 when the processor 210 of the management server 200 executes a program for a database management system.

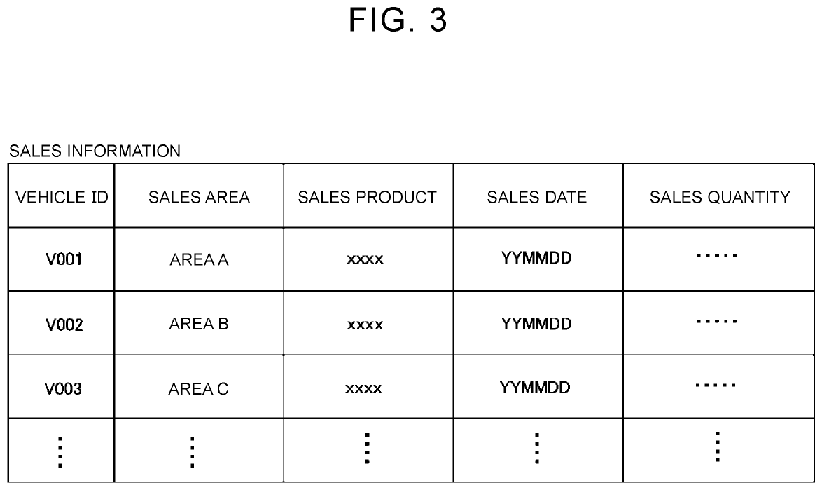

FIG. 3 is a table illustrating an example of a table configuration of the sales information that is stored in the sales information DB 203. As illustrated in FIG. 3, the sales information table has a vehicle ID field, a sales area field, a sales product field, a sales date field, and a sales quantity field. In the vehicle ID field, vehicle ID that is identification information for specifying the vehicle 100 is entered. In the sales area field, the area where the vehicle 100 is dispatched (that is, the area including the current location of the vehicle 100) and where the vehicle 100 sells the specified product is entered. In the sales product field, a product name (or a product code) of the specified product sold by the vehicle 100. As described above, the plural vehicles 100, which are the management targets by the vehicle management system 1, sell the same specified product. Thus, the product name (or the product code) of the same specified product is entered in the sales product field for each of the vehicles 100. In the sales date field, a date when the specified product is sold by the vehicle 100 in the area entered in the sales area field is entered. In the sales quantity field, the quantity of the specified products that is sold to the users by the vehicle 100 on the date entered in the sales date field in the area entered in the sales area field is entered. The sales information, which is sent from each of the vehicles 100 to the management server 200, includes the information that is entered in each of the fields of the sales information table illustrated in FIG. 3 as described above.

Note that each of the vehicles 100 may send the sales information to the management server 200 on each sales date when the specified product is sold. Alternatively, each of the vehicles 100 may send the sales information to the management server 200 every time a specified period in which the specified product is sold elapses. In addition, the sales quantity that is entered in the sales quantity field may be the sales quantity on each sales date, or may be the sales quantity in a specified time slot on each sales date or in the specified period.

The control section 202 has a function of executing calculation processing to control the management server 200. The control section 202 can be realized by the processor 210. The control section 202 has, as functional modules, a demand forecasting section 2021 and a dispatch determining section 2022. The demand forecasting section 2021 and the dispatch determining section 2022 executes dispatch determination processing to determine the redispatch area of each of the plural vehicles 100.

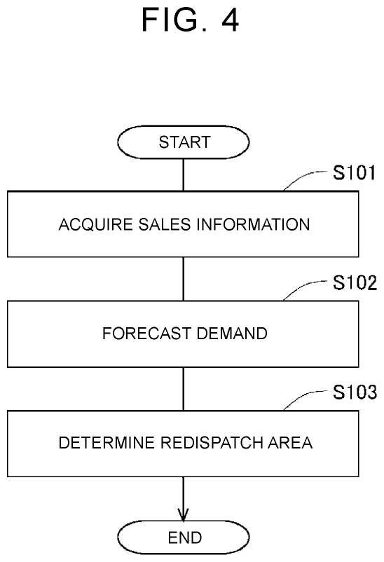

A description will hereinafter be made on the dispatch determination processing that is executed by the demand forecasting section 2021 and the dispatch determining section 2022 with reference to FIG. 4. FIG. 4 is a flowchart of a procedure of the dispatch determination processing. In the dispatch determination processing, first, the demand forecasting section 2021 acquires the sales information that is acquired from each of the vehicles 100 and stored in the sales information DB 203 (that is, the sales information on the specified product in each of the areas) (S101).

Next, the demand forecasting section 2021 forecasts a demand for the specified product in each of the areas (the area A, the area B, the area C . . . ) on the basis of the sales information acquired from the sales information DB 203 (S102). As described above, the sales information acquired from each of the vehicles 100 includes a record of the sales quantity of the specified product in each of the areas. Thus, the demand forecasting section 2021 makes a demand forecast on the basis of this record. For example, the demand forecasting section 2021 may forecast that the demand for the specified product is especially high in the area where the vehicle 100 whose record of the sales quantity of the specified product in a certain period is large. Note that a known method can be adopted as a method for the demand forecast of the specified product that is made by the demand forecasting section 2021.

Next, on the basis of the demand for the specified product in each of the areas, which is forecasted by the demand forecasting section 2021, the dispatch determining section 2022 determines the redispatch area of each of the plural vehicles 100 (S103). At this time, the dispatch determining section 2022 determines the redispatch area of each of the plural vehicles 100 such that the number of the redispatched vehicles 100 is large in the area with the high forecasted demand for the specified product.

When the above dispatch determination processing is executed and the redispatch area of each of the plural vehicles 100 is determined, the control section 202 sends the move command for moving each of the vehicles 100 to the respective redispatch area to each of the vehicles 100 that should be moved to the redispatch areas (that is, the vehicles whose currently dispatched areas differ from the redispatch areas). Here, the move command, which is sent to each of the vehicles 100, includes the location information used to specify the redispatch area.

As described above, when the vehicle 100 receives the move command that is sent from the management server 200, the travel plan that has the redispatch area as the destination is created in the vehicle 100. Then, the vehicle 100 is moved to the redispatch area by the autonomous travel. In this way, the large number of the vehicles 100 is dispatched to the area with the especially high demand for the specified product. Accordingly, it is possible to expand the sales scale of the specified product in the area with the especially high demand for the specified product. Therefore, it is possible to further promote the sales of the specified product when the specified products are sold to the users by the plural vehicles 100.

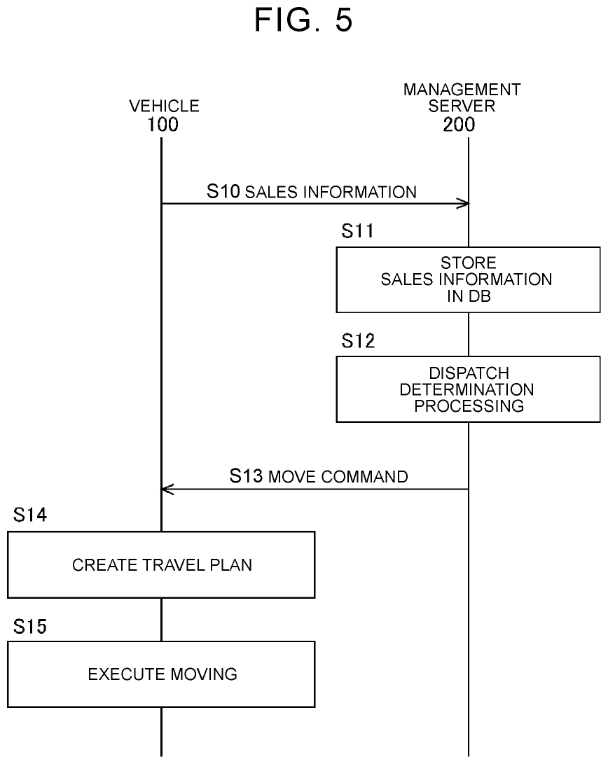

(Information/Processing Flows) A description will herein be made on an information flow between the vehicle 100 and the management server 200 and a flow of each of the processing in the vehicle management system 1 with reference to FIG. 5. FIG. 5 is a sequence chart illustrating the flows of the information and the processing in the vehicle management system 1.

In the vehicle management system 1, under the situation where the plural vehicles 100 are dispatched to the different areas, the sales information is sent from each of the vehicles 100 to the management server 200 (S10). When receiving the sales information from each of the vehicles 100, the management server 200 stores the sales information in the sales information DB 203 (S11). Then, in the management server 200, the dispatch determination processing, which is illustrated in FIG. 4, is executed by using the sales information, which is acquired from each of the vehicles 100 and stored in the sales information DB 203 (S12).

When the dispatch determination processing is executed and the redispatch area of each of the plural vehicles 100 is determined, the move command to the redispatch area is sent to each of the vehicles 100 (S13). In the vehicle 100, when the move command is received from the management server 200, the travel plan is created on the basis of the move command (S14). Then, on the basis of the created travel plan, the movement of the vehicle 100 to the redispatch area is executed (S15).

In the vehicle management system 1 in this embodiment, each of the vehicles 100 that are dispatched to the different areas may sell the specified product on the same sales date, and the sales information on the sales date may be collected in the management server 200 from each of the vehicles 100. Then, before the sales start on the following day of the sales date when the sales information is collected, the dispatch determination processing may be executed in the management server 200, and the movement of each of the vehicles 100 to the redispatch area may be completed. As a result, it is possible to expand the sales scale of the specified product in the area with the especially high demand for the specified product from the following day of the sales date when the sales information is collected.

In the vehicle management system 1 in this embodiment, the sales information within a specified time from the sales start on the same sales date may be collected in the management server 200 from each of the vehicles 100 that are dispatched to the different areas. Then, within the sales date when the sales information is collected, the dispatch determination processing may be executed in the management server 200, and the movement of each of the vehicles 100 to the redispatch area may be completed. As a result, it is possible to expand the sales scale of the specified product in the area with the especially high demand for the specified product on the sales date when the sales information is collected.

### MODIFIED EXAMPLES

As described above, in this embodiment, the redispatch area of each of the plural vehicles 100 is determined in the dispatch determination processing executed by the management server 200 such that the number of the redispatched vehicles 100 is large in the area with the high forecasted demand for the specified product. However, the method for determining the redispatch area of each of the plural vehicles 100 is not limited thereto. For example, in the dispatch determination processing, of the plural areas where the vehicles 100 are dispatched, a prioritized area that is the area with the highest forecasted demand for the specified product may be derived. Then, the redispatch areas of the vehicles 100, which are dispatched in the areas other than the prioritized area, of the plural vehicles 100 may be determined to be the prioritized area. In this way, it is possible to expand the sales scale of the specified product in the prioritized area as much as possible. Therefore, also with the dispatch determination processing, it is possible to further promote the sales of the specified product when the specified products are sold to the users by the plural vehicles 100.

Note that, in the case where the vehicle 100 is a vehicle that sells the specified service to the user, similar to the above, a demand for the specified service in each of the areas is forecasted on the basis of sales information on the specified service acquired from each of the vehicles 100. Then, the redispatch area of each of the plural vehicles 100 is determined on the basis of the forecasted demand for the specified service. In this way, the large number of the vehicles 100 is dispatched to the area with the especially high demand for the specified service. Accordingly, it is possible to expand the sales scale of the specified service in the area with the especially high demand for the specified service. Therefore, it is possible to further promote the sales of the specified service when the specified service is sold to the users by the plural vehicles 100.

### OTHER EMBODIMENTS

The above embodiment is merely an example, and the disclosure can appropriately be changed for implementation within the scope that does not depart from the gist of the disclosure. In addition, the processing and the means described in the present disclosure can freely be combined for the implementation unless otherwise contradicted technically.

The processing described as being executed by the single device may be shared and executed by plural devices. The processing described as being executed by the different devices may be executed by the single device. It is possible to flexibly change which hardware configuration (server configuration) realizes each of the functions of the computer system.

The disclosure can also be realized when a computer program that is built with the functions described in the above embodiment is supplied to a computer and one or more processors provided in the computer read and execute the program. Such a computer program may be provided to the computer by a non-transitory computer readable storage medium that can be connected to a system bus of the computer, or may be provided to the computer via the network. Examples of the non-transitory computer readable storage medium are any type of disks such as magnetic disks (a Floppy® disk, the hard disk drive (HDD), and the like) and optical discs (the CD-ROM, the DVD, the Blu-ray disc, and the like), the read only memory (ROM), the random access memory (RAM), the EPROM, EEPROM, a magnetic card, the flash memory, an optical card, and any type of medium suited for storing an electronic command.

What is claimed is:

1. An information processor that manages travel of plural vehicles capable of autonomous travel, each of the plural vehicles being a store vehicle that sells the same specified product or the same specified service to a user, the information processor comprising:
a control section that:
acquires sales information that includes information on a sales quantity of the specified product or the specified service by each of the vehicles under a situation where the plural vehicles are dispatched to different areas;
forecasts a demand for the specified product or the specified service in each of the areas where the vehicles are dispatched on the basis of the sales information acquired from each of the plural vehicles;
determines a redispatch area that is an area where each of the plural vehicles is redispatched on the basis of the forecasted demand for the specified product or the specified service in each of the areas; and
sends a move command for moving each of the plural vehicles to the respective determined redispatch area to each of the plural vehicles.

2. The information processor according to claim 1, wherein
the control section determines the redispatch area of each of the plural vehicles such that the number of the redispatched vehicles is large in the area with the high forecasted demand for the specified product or the specified service.

3. The information processor according to claim 1, wherein
of the plural areas where the plural vehicles are dispatched, the control section derives a prioritized area that is an area with the highest forecasted demand for the specified product or the specified service, and determines the redispatch area of the vehicle, which is dispatched to the area other than the prioritized area, of the plural vehicles to be the prioritized area.

4. A vehicle management system comprising:
plural vehicles capable of autonomous travel; and
an information processor that manages travel of the plural vehicles, wherein
each of the plural vehicles is a store vehicle that sells the same specified product or the same specified service to a user, and
the information processor includes:
a first control section that:
acquires sales information that includes information on a sales quantity of the specified product or the specified service by each of the vehicles under a situation where the plural vehicles are dispatched to different areas;
forecasts a demand for the specified product or the specified service in each of the plural areas where the vehicles are dispatched on the basis of the sales information acquired from each of the plural vehicles;
determines an area where each of the plural vehicles is redispatched on the basis of the forecasted demand for the specified product or the specified service in each of the plural areas; and
sends a move command for moving each of the plural vehicles to the respective determined redispatch area to each of the plural vehicles; and
a second control section that:
makes each of the plural vehicles send the sales information to the information processor;
receives the move command to the redispatch area that is sent from the information processor; and
moves a host vehicle to the redispatch area on the basis of the received move command.

5. An information processing method for managing travel of plural vehicles capable of autonomous travel by a computer, each of the plural vehicles being a store vehicle that sells the same specified product or the same specified service to a user, the information processing method comprising:
acquiring sales information that includes information on a sales quantity of the specified product or the specified service by each of the vehicles under a situation where the plural vehicles are dispatched to different areas;
forecasting a demand for the specified product or the specified service in each of the plural areas where the vehicles are dispatched on the basis of the sales information acquired from each of the plural vehicles;
determining an area where each of the plural vehicles is redispatched on the basis of the forecasted demand for the specified product or the specified service in each of the plural areas; and
sending a move command for moving each of the plural vehicles to the respective determined redispatch area to each of the plural vehicles.

6. A program that makes a computer manage travel of plural vehicles capable of autonomous travel, each of the plural vehicles being a store vehicle that sells the same specified product or the same specified service to a user, the program making the computer:
acquire sales information that includes information on a sales quantity of the specified product or the specified service by each of the vehicles under a situation where the plural vehicles are dispatched to different areas;
forecast a demand for the specified product or the specified service in each of the plural areas where the vehicles are dispatched on the basis of the sales information acquired from each of the plural vehicles;
determine an area where each of the plural vehicles is redispatched on the basis of the forecasted demand for the specified product or the specified service in each of the plural areas; and
send a move command for moving each of the plural vehicles to the respective determined redispatch area to each of the plural vehicles.
